(19) United States
(12) Patent Application Publication
(10) Pub. No.: US 2002/0188633 A1
(43) Pub. Date: Dec. 12, 2002

(54) Generating HTML using templates and cached files

(76) Inventors: Craig Davis, Meridian, ID (US); Sukh Sodhi, Boise, ID (US); Michael Knapp, Meridian, ID (US); Mungara Vijay Ranjan, Beaverton, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/876,825

(22) Filed: Jun. 6, 2001

(51) Int. Cl. G06F 17/21

(52) U.S. Cl. 707/513; 707/530

(57) ABSTRACT

A system for generating web pages includes a web server that receives requests from a web browser. The web server then checks a primary cache to see if a previously generated web page exists in the primary cache. If so, the web page is returned to the user. Otherwise, the web server checks a JIT cache to determine if a previously generated JIT cache file exists. The JIT cache file will have been previously processed in a manner such that all tag except for specially designated retain tags have been replaced with data values. The retain tags are then processed to provide what are typically user specific values, and the generated web page is returned to the requester. If neither a primary cached file or a JIT cache file exists, the system creates will create one. A primary cache file is created if no retain tags are present in a template file for the web page. Otherwise a JIT cache file is created.

### FIELD

The present invention relates generally to computerized systems and methods for generating HTML, and more particularly to using templates and cached files to generate HTML.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2001, Micron Technology, Inc. All Rights Reserved.

### BACKGROUND

The use of the Internet, and in particular, the World Wide Web (“Web”) continues to grow at a sometimes astounding rate. Each day, more systems and more people connect to the Internet to browse web pages to search for and acquire information, purchase goods and services, access e-mail, view advertisements and other web-based activity. A web page is typically defined in a language known in the art as Hypertext Markup Language (HTML). Web browsers such as Microsoft Internet Explorer, Netscape Navigator or Mosaic request web pages from web servers. The server communicates the HTML defining the page to the user's browser, typically using the HTTP (Hypertext Transfer Protocol). A request received by a web page server from a web browser is sometimes referred to as a “hit” on the web page. As one would expect, web pages and web sites vary in popularity, with some pages receiving relatively few hits while others can receive over one million hits a day.

For web pages devoted to electronic commerce (e-commerce), it is desirable for the web page to receive large numbers of hits. However, receiving large numbers of hits can pose problems for the software and hardware on the server that generate the web page. For example, a web server hosting a web page that receives large numbers of hits must typically have sufficient resources in terms of network bandwidth, disk space, processing power, and memory resources to handle the number of hits received without unacceptable delay.

Furthermore, many web pages are dynamically generated based on user input. For instance, it is often desirable to limit the amount of information presented on a web page to avoid a page that must be scrolled for a long period of time in order to view the entire page. The web page can provide input fields that are used to limit the scope of the information that is presented to the user in a subsequent web page that is dynamically generated to reflect the user's input. Consider the example of a user that desires to purchase computer memory from an online vendor. Rather than scroll through all of the types and sizes of memory available for all types of computer system, the user will typically want to see a web page that displays only those memory components that are compatible with the user's computer system and having the desired size. Thus the web page will typically provide a means for inputting the desired parameters, search one or more data sources for matches based on the input parameters, and then dynamically generate the HTML for a web page that displays the matches.

As can be readily seen, dynamically generating a web page requires more resources than transferring a statically defined web page. Typically the web page definition must be parsed and passed through various DLLS (Dynamic Link Libraries) before being sent to the requesting web browser. The time required to process the page is significant, because studies have shown that most uses will not wait longer than eight seconds for a web page to load before taking their business elsewhere on the web.

Furthermore, a popular web page will often require the design efforts of two different types of people. The first type comprises marketing personnel, the second type comprises web page developers having expertise in the software used to design and implement web pages. Often there are problems associated with having two disparate groups responsible for the web page. Marketing people responsible for the look and feel of the web page may not like changes to the look and feel brought about when web page developers alter the code for performance or maintainability reasons. Likewise, web page developers may feel that the marketing personnel are “breaking” the web site when they make changes to the look and feel of the web site.

In view of the above, there is a need in the art for a system that can rapidly generate web pages without consuming large amounts of system resources.

### SUMMARY

The above-mentioned shortcomings, disadvantages and problems are addressed by the present invention, which will be understood by reading and studying the following specification.

In one embodiment, system for generating web pages includes a web server that receives requests from a web browser. The web server then checks a primary cache to see if a previously generated web page exists in the primary cache. If so, the web page is returned to the user. Otherwise, the web server checks a JIT cache to determine if a previously generated JIT cache file exists. The JIT cache file will have been previously processed in a manner such that all tag except for specially designated retain tags have been replaced with data values. The retain tags are then processed to provide what are typically user specific values, and the generated web page is returned to the requester.

If neither a primary cached file or a JIT cache file exists, the system creates will create one. A primary cache file is created if no retain tags are present in a template file for the web page. Otherwise a JIT cache file is created.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of the hardware and operating environment in which different embodiments of the invention can be practiced;

FIG. 2 is a system level overview of the software components according to an embodiment of the invention;

FIGS. 3A and 3B are flow charts illustrating methods for generating web pages according to an exemplary embodiment of the invention;

FIGS. 4A and 4B are exemplary excerpts of template files illustrating a data access feature according to various embodiments of the invention;

FIGS. 5A-5C are exemplary excerpts of files used at various stages of generating an exemplary web page; and

FIG. 5D is an exemplary web page produced by embodiments of the invention from the examples illustrated in FIGS. 5A-5C.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description.

The detailed description is divided into multiple sections. In the first section the hardware and operating environment of different embodiments of the invention is described. In the second section, the software environment of varying embodiments of the invention is described. In the third section, methods according to various embodiments of the invention are described. In the final section, a conclusion is provided.

### Hardware and Operating Environment

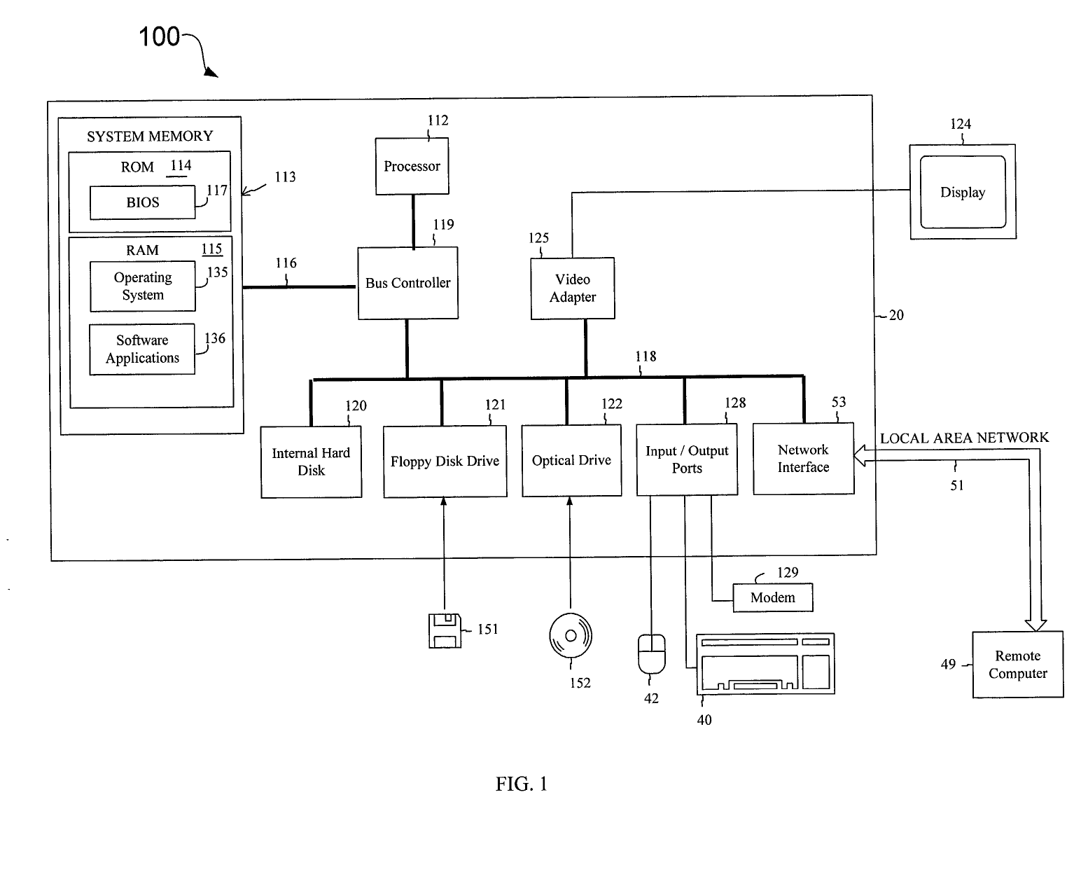

FIG. 1 is a diagram of the hardware and operating environment in conjunction with which embodiments of the invention may be practiced. The description of FIG. 1 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer or a server computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 1, the computing system 100 includes a processor. The invention can be implemented on computers based upon microprocessors such as the PENTIUM® family of microprocessors manufactured by the Intel Corporation, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. Computing system 100 represents any personal computer, laptop, server, or even a battery-powered, pocket-sized, mobile computer known as a hand-held PC.

The computing system 100 includes system memory 113 (including read-only memory (ROM) 114 and random access memory (RAM) 115), which is connected to the processor 112 by a system data/address bus 116. ROM 114 represents any device that is primarily read-only including electrically erasable programmable read-only memory (EEPROM), flash memory, etc. RAM 115 represents any random access memory such as Synchronous Dynamic Random Access Memory.

Within the computing system 100, input/output bus 118 is connected to the data/address bus 116 via bus controller 119. In one embodiment, input/output bus 118 is implemented as a standard Peripheral Component Interconnect (PCI) bus. The bus controller 119 examines all signals from the processor 112 to route the signals to the appropriate bus. Signals between the processor 112 and the system memory 113 are merely passed through the bus controller 119. However, signals from the processor 112 intended for devices other than system memory 113 are routed onto the input/output bus 118.

Various devices are connected to the input/output bus 118 including hard disk drive 120, floppy drive 121 that is used to read floppy disk 151, and optical drive 122, such as a CD-ROM drive that is used to read an optical disk 152. The video display 124 or other kind of display device is connected to the input/output bus 118 via a video adapter 125.

A user enters commands and information into the computing system 100 by using a keyboard 40 and/or pointing device, such as a mouse 42, which are connected to bus 118 via input/output ports 128. Other types of pointing devices (not shown in FIG. 1) include track pads, track balls, joy sticks, data gloves, head trackers, and other devices suitable for positioning a cursor on the video display 124.

As shown in FIG. 1, the computing system 100 also includes a modem 129. Although illustrated in FIG. 1 as external to the computing system 100, those of ordinary skill in the art will quickly recognize that the modem 129 may also be internal to the computing system 100. The modem 129 is typically used to communicate over wide area networks (not shown), such as the global Internet. The computing system may also contain a network interface card 53, as is known in the art, for communication over a network.

Software applications 136 and data are typically stored via one of the memory storage devices, which may include the hard disk 120, floppy disk 151, CD-ROM 152 and are copied to RAM 115 for execution. In one embodiment, however, software applications 136 are stored in ROM 114 and are copied to RAM 115 for execution or are executed directly from ROM 114.

In general, the operating system 135 executes software applications 136 and carries out instructions issued by the user. For example, when the user wants to load a software application 136, the operating system 135 interprets the instruction and causes the processor 112 to load software application 136 into RAM 115 from either the hard disk 120 or the optical disk 152. Once software application 136 is loaded into the RAM 115, it can be used by the processor 112. In case of large software applications 136, processor 112 loads various portions of program modules into RAM 115 as needed.

The Basic Input/Output System (BIOS) 117 for the computing system 100 is stored in ROM 114 and is loaded into RAM 115 upon booting. Those skilled in the art will recognize that the BIOS 117 is a set of basic executable routines that have conventionally helped to transfer information between the computing resources within the computing system 100. These low-level service routines are used by operating system 135 or other software applications 136.

In one embodiment computing system 100 includes a registry (not shown) which is a system database that holds configuration information for computing system 100. For example, Windows® 95, Windows 98®, Windows Me®, Windows® NT, and Windows 2000® by Microsoft maintain the registry in two hidden files, called USER.DAT and SYSTEM.DAT, located on a permanent storage device such as an internal disk.

### Software Environment

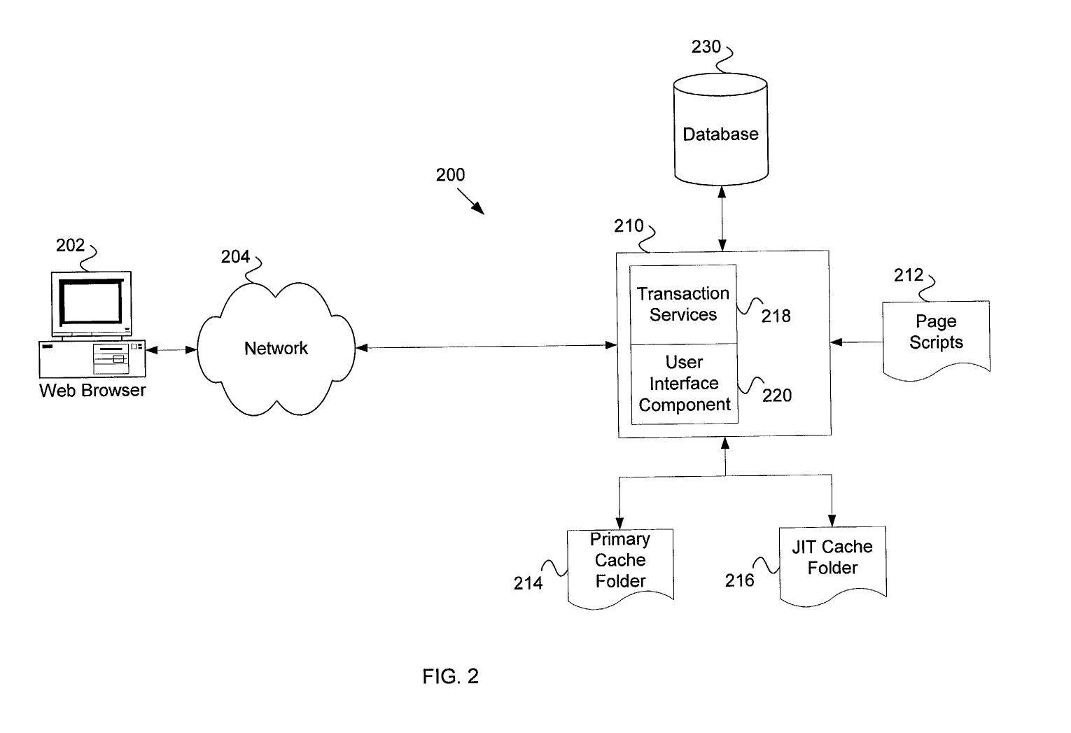

The embodiments of the invention describe a novel software environment of systems and methods that generate HTML for web pages using various data sources and cached information. FIG. 2 is a block diagram describing the major components that interact with, and comprise such a system. In one embodiment of the invention, web page generation system 200 includes a web server 210, database 230, page script files 212, and caches 214 and 216. System 200 is typically communicably coupled to a network 204 and can receive requests from a web browser 202.

Web browser 202 is a client application that makes requests for web pages from web server 210. Web browser 202 can be any type of browser capable of interpreting and displaying HTML. Examples of such web browsers include Microsoft Internet Explorer, Netscape Navigator, and NCSA Mosaic. The invention is not limited to any particular web browser.

Web server 210 is a server application that provides web pages to client web browsers 202. In one embodiment of the invention, web server 210 is the Microsoft IIS (Internet Information Services) server. However, the invention is not limited to the IIS server system, or to any particular web server system. In alternative embodiments of the invention, web server 210 can be the Apache web server system or the iPlanet web server system.

Web server 210 communicates with web browser 202 via network 204. In general, network 204 can be any type of network capable of transmitting and receiving data, including both wired and wireless networks. In some embodiments, network 204 is what is commonly known as the Internet. In alternative embodiments, network 204 can be an intranet or a local area network. The invention is not limited to any particular type of network.

Upon receipt of a request for a web page from web browser 202, web server 210 determines of the requested page is statically defined or if it contains dynamically changing content that must be generated. In the case of a generated web page, web server 210 typically reads a page script 212. Page script 212 contains instructions and data that define how the web page is to be created. In one embodiment of the invention, page script 212 comprises what is known in the art as an Active Server Page (ASP), with extensions to the ASP specification as described below. ASPs can utilize scripting such as ActiveX scripting, including Visual Basic or Jscript code, to specify how a page is to be generated. However, the invention is not limited to ASPs, and alternative forms of script pages are within the scope of the invention.

Page script 212 can include instructions directing web server 210 to obtain data for the web page from a database 230. In one embodiment, database 230 comprises an Oracle database system. In alternative embodiments, database 230 can comprise database systems such as Informix, Sybase, and/or SQL Server. Furthermore, database 230 can be a file system based database, or it can be an object-oriented database.

During the process of generating a web page, web server 210 determines if the web page can be generated using cached information. In some embodiments of the invention, web server 210 maintains two caches, a primary cache 214 and a JIT (Just-in-time) cache 216. In one embodiment, primary cache 214 contains HTML for web pages that were generated in response to previous browser requests. If web server 210 determines that a requested web page is in the primary cache 214, it can return the HTML to the requesting web browser 201 without having to regenerate the page.

In one embodiment of the invention, JIT cache 216 comprises partially processed page scripts that were generated in response to previous requests for web pages. In one embodiment, these partially processed scripts comprise HTML resulting from a previous request for a page script combined with unprocessed script code. Typically the unprocessed script code will be code that obtains data that changes frequently. For example, some web pages ask for personally identifying data such as a name, address, username or password. It is impractical to completely cache such information, because it would result in an overwhelming number of cached files, one for each person making a page request. Thus page script 212 in the various embodiments of the invention contain information on what data is to be retained in the JIT cache 216, and what information must be regenerated. In alternative embodiments of the invention, the primary cache 214 and JIT cache 216 are maintained as a single JIT cache 216.

Further details on how web server 210 uses page scripts 212 and caches 214 and 216 are provided below in the next section.

In some embodiments of the invention, web server 210 includes a transaction services component 218, and a user interface component 220. Transaction services component 218 is a component that provides a transaction-oriented interface for responding to web page requests and for interacting with database 230. In one embodiment of the invention, transaction services component is the Microsoft Transaction Services (MTS) component. However, the invention is not limited to any particular transaction services component.

In some embodiments of the invention, the functionality associated with generating a web page is performed by a user interface component 220. In these embodiments, the user interface component is instantiated by web server 210 upon receipt of a web page request, and handles the web page generation required by the request, including maintaining a primary cache 214 and JIT cache 216.

While the above system 200 has been described as a client/server system, the invention is not limited to a client/server architecture. The various components described above could be implemented as a three-tier system, or alternatively, as a multi-tier or N-tier system. Furthermore, the system can be implemented in a number of different component models, including Microsoft's ActiveX, or COM (Component Object Model), or alternatively as Javabean components.

This section has described the various software components in a system that generates web pages from various data sources, including page scripts, databases and cached files. As those of skill in the art will appreciate, the software can be written in any of a number of programming languages known in the art, including but not limited to C/C++, Visual Basic, Java, Smalltalk, Pascal, Ada and similar programming languages. The invention is not limited to any particular programming language for implementation.

### Method for Processing Highly Contested Critical Sections

The previous section presented a system level description of an embodiment of the invention. In this section, methods within embodiments of the invention will be described with reference to flowcharts describing tasks to be performed by computer programs implementing the method using computer-executable instructions. The computerized method is desirably realized at least in part as one or more programs running on a computer—that is, as a program executed from a computer-readable medium such as a memory by a processor of a computer. The programs are desirably storable on a computer-readable medium such as a floppy disk, CD-ROM, DVD-ROM, or Compact Flash (CF) card for distribution, installation and execution on a suitably equipped computer. The programs may also be stored on one computer system and transferred to another computer system via a network connecting the two systems, thus at least temporarily existing on a carrier wave or some other form of transmission.

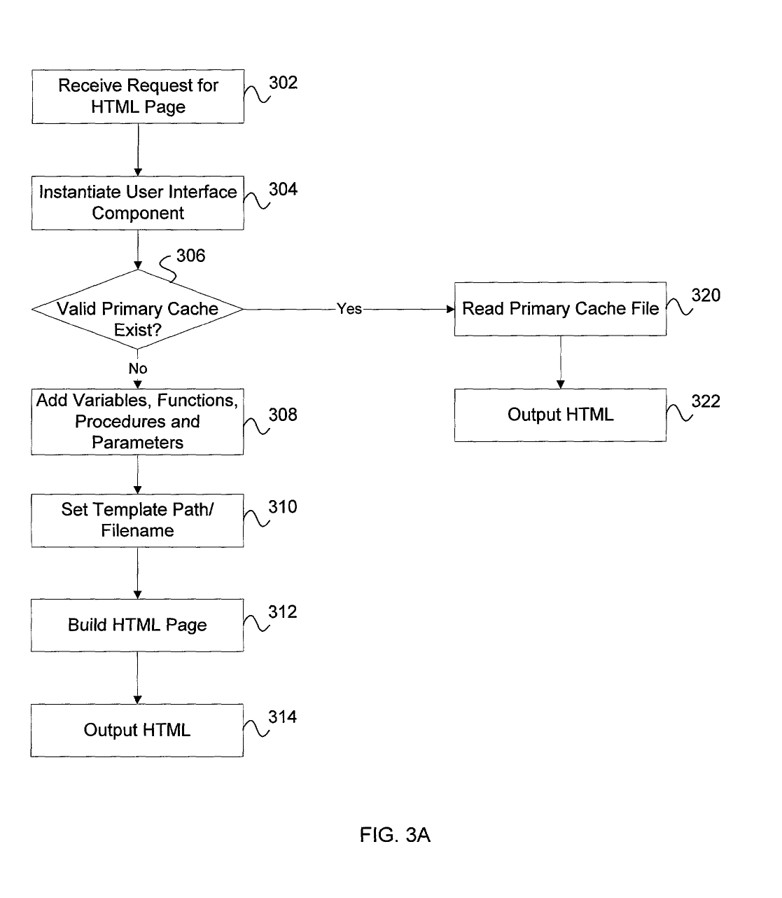

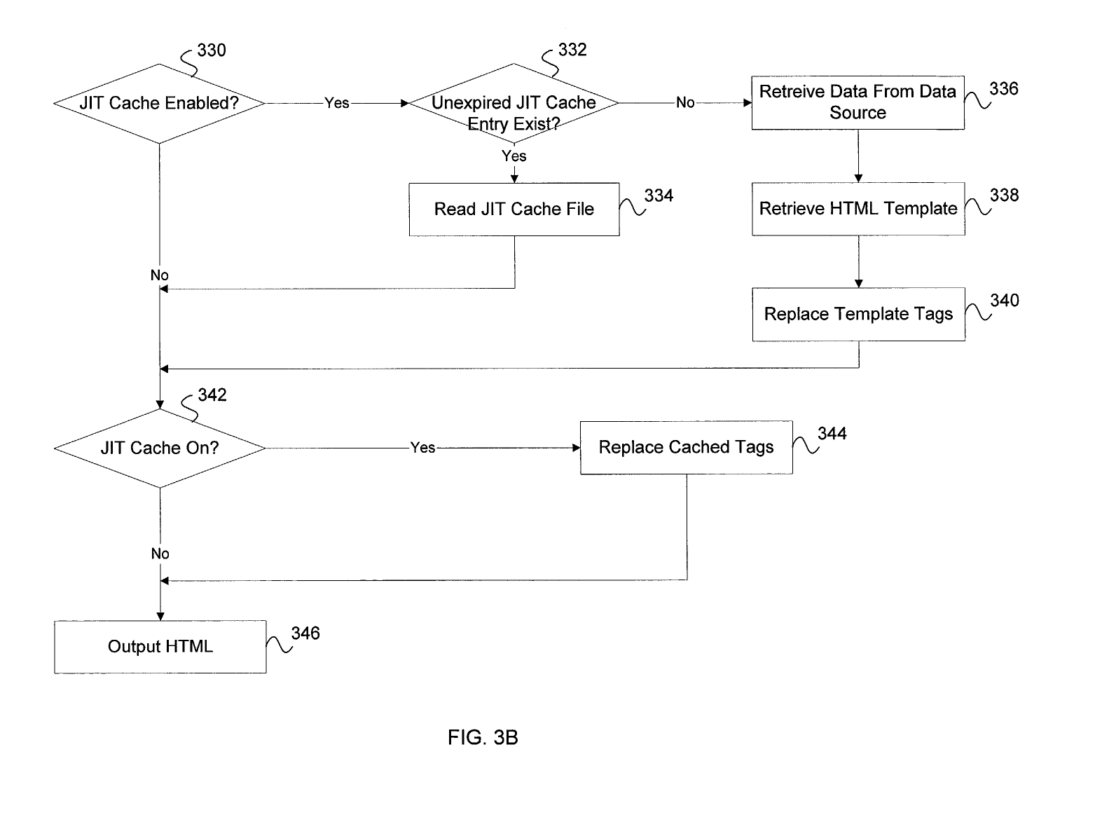

In FIG. 3A, a flowchart is shown that illustrates a method for generating a web page according to an embodiment of the invention. The method begins when a system, such as a web server 210, receives a request for a web page script (block 302). In some embodiments of the invention, in particular those that provide support for components, a user interface component is instantiated to process the web page generation (block 304). However, instantiation of a user interface component is not a requirement in all cases, the method can be performed outside of a component environment.

Next, in some embodiments, the system checks to see if a valid primary cache file representing the requested page exists (block 306). If a cached version exists, the method proceeds to read the cached file from the primary cache (block 320). The HTML code from the cached file is then returned to the requesting browser (block 322).

If the check at block 306 determines that a cached file for the requested web page is not in the primary cache, the system proceeds to determine the variables, functions, procedures and parameters that will be necessary to generate the HTML for the web page (block 308). In those embodiments in which a user interface component is instantiated, the functions, procedures and parameters are added to the component. It should be noted that the variables, functions, procedures, and parameters are not actually processed at this block, rather they are made available for later processing should it be necessary. Variables can include ASP page level, session level or application level variables. These variables can also be user-specific variables such their cookie or session id. In addition, variables can be embedded in a URL (Uniform Resource Locator), or they can comprise data entered on a previous page.

Typically functions will be added if data transformation may be required. For example, there may be a requirement may that if the quantity-on-hand for an item displayed on a web page is zero that the text string “Out of Stock” is displayed in the page rather than, or in addition to the number ‘0’. Further, functions can also be used for displaying optional HTML blocks depending on conditions met for the specific user.

Stored procedures can be added when it is necessary to obtain record sets from a database such as database 230. Alternatively, record sets can be passed into the method. The template layout determines how each data element that is returned from these data sources will be presented. The template is concerned only with how the data is placed within the HTML. It is not concerned with any logic or business rules. In some embodiments, the template includes tags that allow single records from a record set to be displayed (Master Tags <WMASTER@>) or the template can describe data that is returned in multiple rows in the record set (Detail Tags <WDETAIL@>). In some embodiments, a special Move Next Tag <WMOVE_NEXT@> instructs the system to move to the next row but display it differently. Examples of the use of the tags described above will be presented in the next section.

In addition to determining required functions, variables, stored procedures, and parameters, the system sets the path name and file name that contains the desired template file (block 310).

Next, the system executing the method proceeds to build the HTML page (block 312). FIG. 3B provides further details regarding building the HTML, including checking a Just-in-Time (JIT) cache.

At block 330, one embodiment of the invention checks to determine if JIT caching is enabled. Next, the system checks to see if a valid JIT cache entry exists for the requested web page (block 332). In some embodiments, in order for a JIT cache entry for a requested entry to be valid, it must not have expired. A cache entry is expired if it is older than a predetermined parameter. In one embodiment, the expiry parameter is determined as a parameter as described above regarding block 308. In alternative embodiments, configuration files, registry entries, or environment variables can determine the expiry parameter.

If a valid cache entry exists, the system then reads the JIT cache file (block 334). As noted above, the JIT cache file will be the output from a previously processed template with sections appearing within a retain tag left unprocessed.

Otherwise, the system proceeds to retrieve data using the data sources determined at block 308. As noted above, these data sources can include variables, functions, parameters, and stored procedures. The data can be obtained from database 230 (FIG. 2), data files, object oriented database or other sources of data known in the art. The system also retrieves the HTML template determined at block 310 (block 338). The system uses the data obtained at block 336 to replace template tags in the HTML template (block 340). In addition, the processed template is output to a cache file that is placed in the JIT cache to be read upon future page requests. It is possible that during high traffic times, two concurrent users could be attempting to write the file at the same time. In this case, the second user's error is ignored by some embodiments of the invention, since the second attempt to write the file is not necessary. All the required data for the second user's request is in memory and will successfully build a page despite the failed write attempt. Any additional page requests before the cache expires will avoid the processing in blocks 336-340. It should be noted that tags appearing within retain tags are not processed, as they typically represent information that changes frequently, such as user-specific data, and is therefore not amenable to caching.

At block 342, a check is made to determine if JIT caching is turned on for this entry. If so, the system proceeds to replace retained cache tags (block 344). In one embodiment of the invention, retained tags are indicated by called <WR@> tags which tell the system to retain these tags in the JIT cache file. If the system encounters these tags during processing it replaces the tags before outputting the final HTML to the client's browser.

Returning to FIG. 3A, the HTML resulting from the above-described blocks is returned to the requesting browser (block 314).

In the discussion above, tags have been described and given particular labels. Specifically, the WR, WMASTER, WDETAIL and WMOVENEXT tags have been described. It should be noted that the invention is not limited to using these particular labels for the functionality indicated, and that other labels could be substituted for those identified above.

### Exemplary Templates and Template Output

The previous sections have provided a description of systems and methods using various data sources, tags, and cache files to achieve rapid generation of HTML. This section provides exemplary input templates and output web pages that illustrate features of the systems and methods described above.

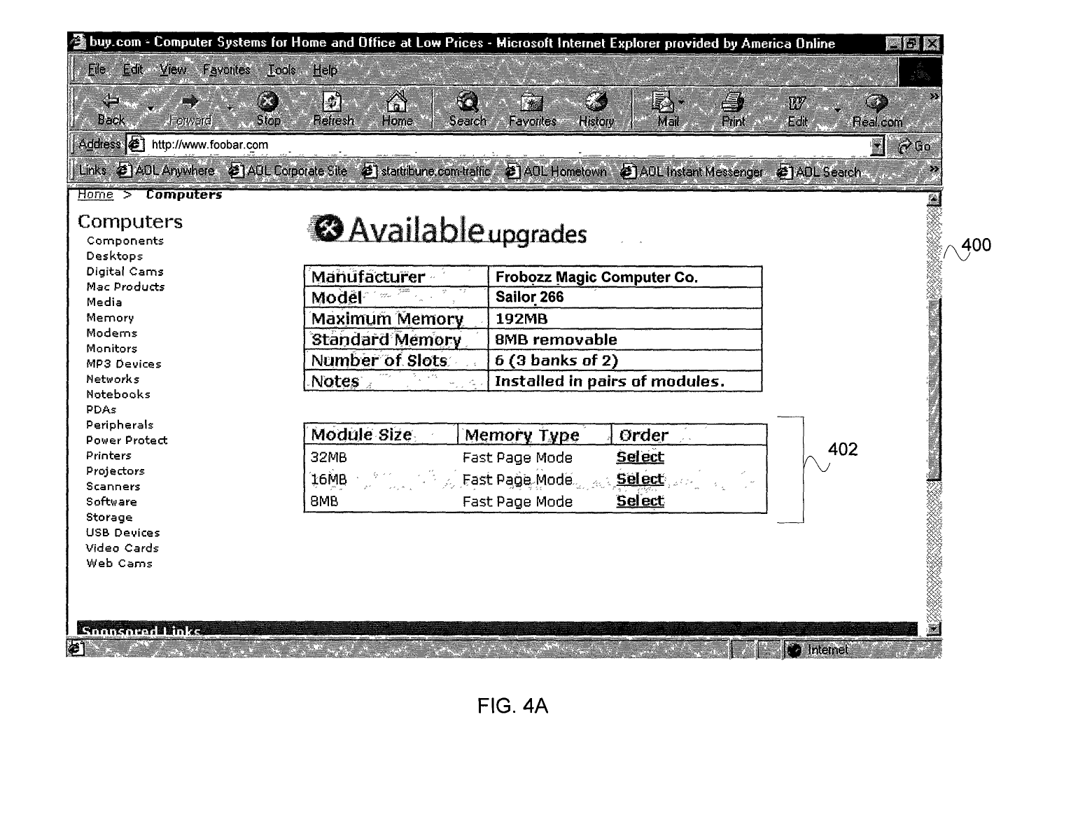

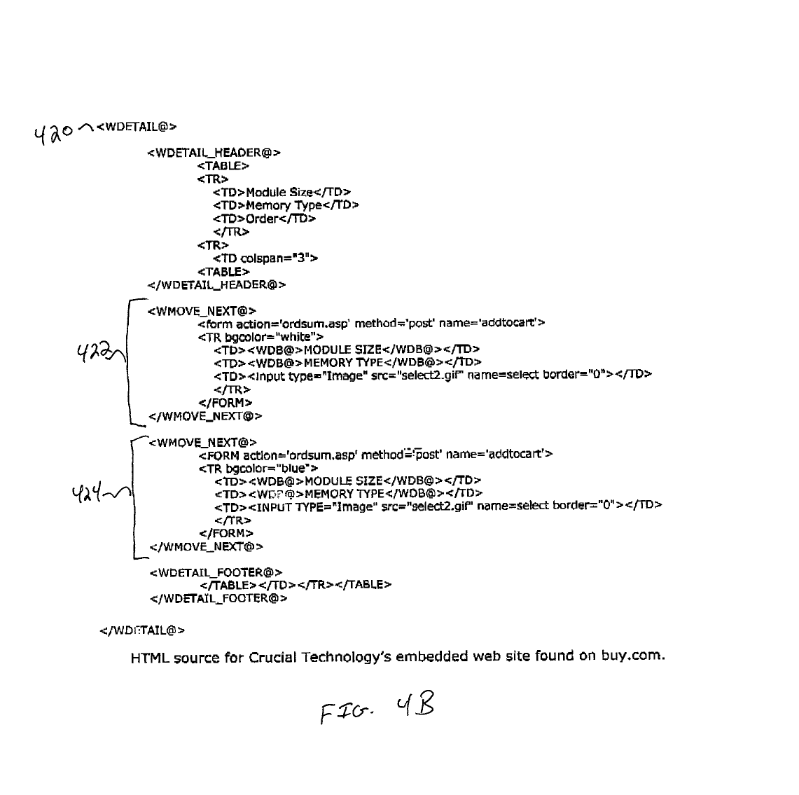

FIGS. 4A and 4B provide an exemplary template and generated web page illustrating the WDETAIL and WMOVENEXT tags described above. FIG. 4A is an exemplary web page 400 generated according to the systems and methods of an embodiment of the invention. As illustrated FIG. 4A, includes a memory search results section 402 representing rows in a database that match a user's input parameters. As shown, the rows alternate in color from a white background to a colored background (illustrated as gray in FIG. 4A).

FIG. 4B illustrates exemplary tags used in embodiments of the invention that result in the HTML code to display web page 400. Detail tag 420 introduces the detail section and provides header information. Row tag sections 422 and 424 illustrate template code that causes the background color to alternate as illustrated in section 402 above. Section 422 includes a first <WMOVE NEXT@> tag that causes a white background to be displayed and section 424 shows a second <WMOVE NEXT@> tag that causes a blue background to be displayed.

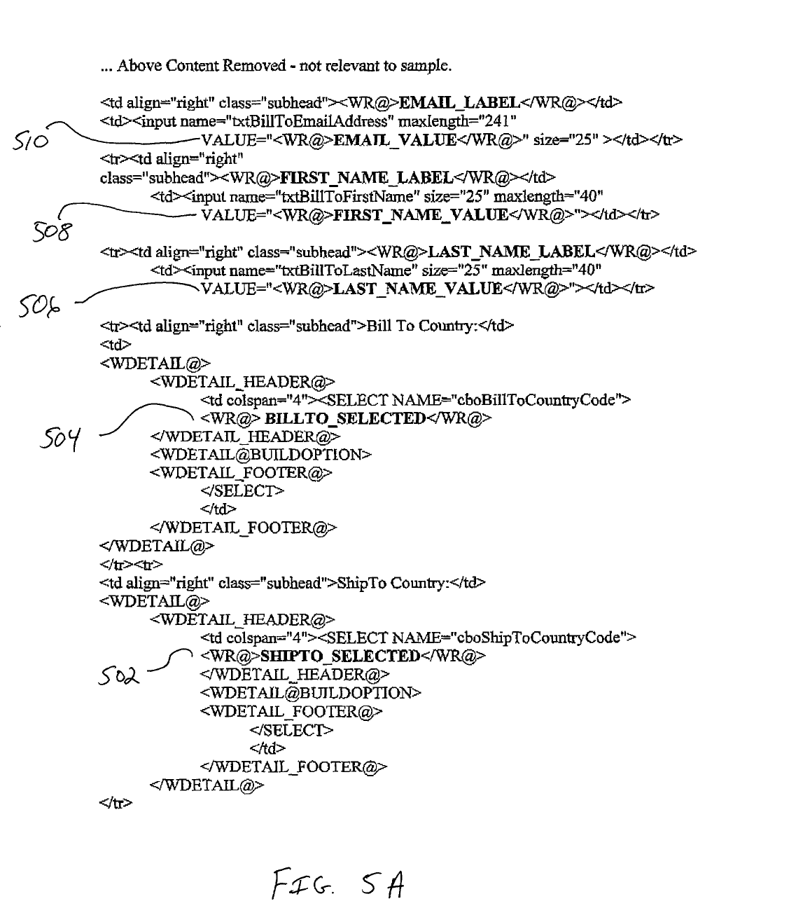

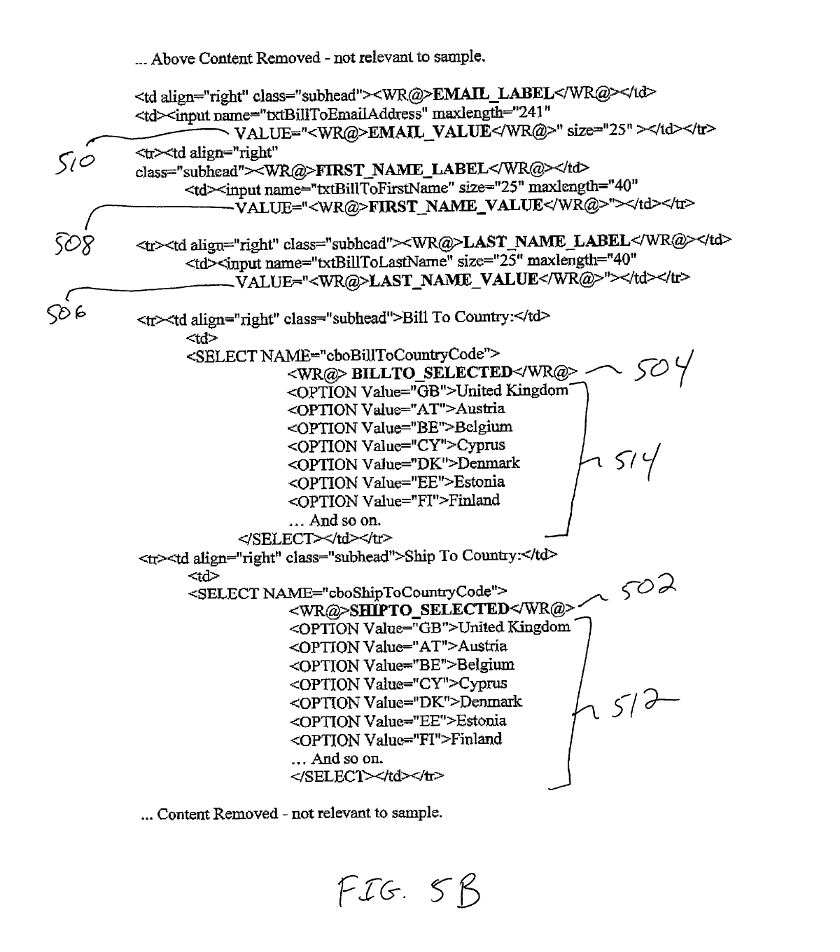

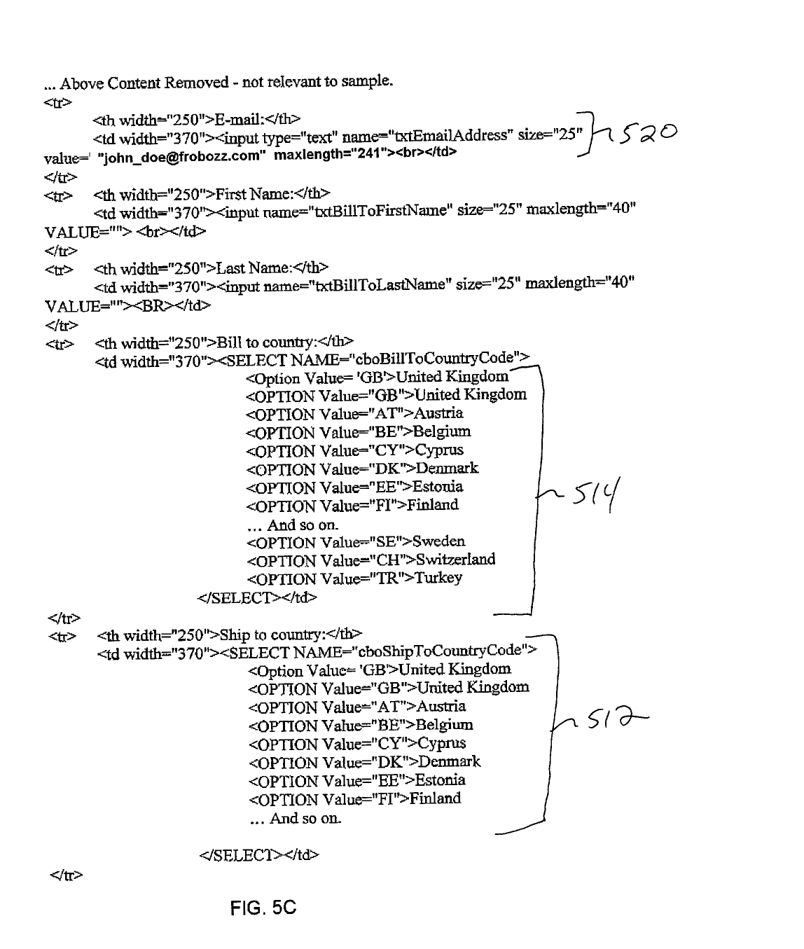

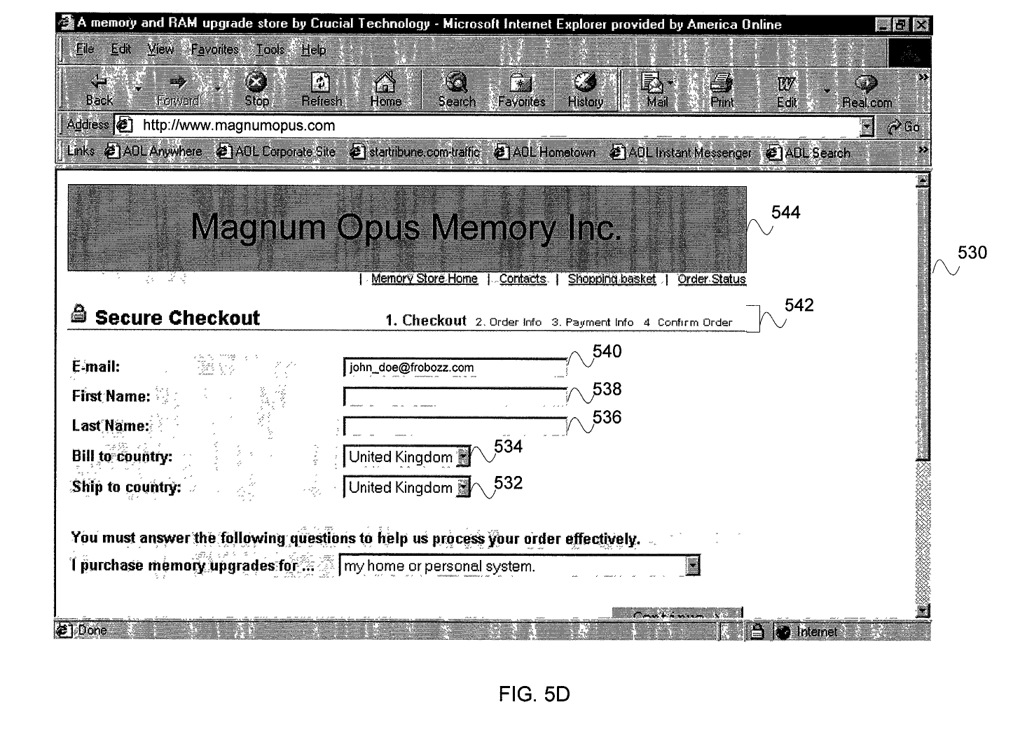

FIGS. 5A, 5B and 5C illustrate an exemplary template file, a JIT cache file, and the resulting output file that produce an exemplary web page illustrated in FIG. 5D. In the examples shown, details that are not required to provide an enabling description of the operation of the embodiments of the invention have been omitted.

FIG. 5D is an exemplary web page 530 produced according to an embodiment of the invention. As illustrated, web page 530 includes a banner 544 and checkout information 542 that generally does not vary as individual users access the web page. In addition, web page 530 includes user specific information such as e-mail address 540, first name 538, last name 536, bill to country selection 534 and ship to country selection 532. Each of these user-specific items will most likely vary from user to user.

FIG. 5A illustrates an excerpt from a template file used to generate web page 530. Similar to FIG. 4B, FIG. 5A includes detail tags that are replaced with record sets from a data source. Of specific interest in this example are the retain tags 502-510. Each of the retain tags bracket the user-specific information noted on web page 530 and correspond to fields 532-540 in FIG. 5D.

FIG. 5B illustrates an excerpt from an exemplary cache file created by applying the systems and methods of various embodiments of the invention to the exemplary template file of FIG. 5A. The exemplary cache file illustrates that tags that are not user-specific, i.e. tags that have not been bracketed by the retain tag <WR@> have been processed and cached. Among other items, the options for drop down selection 534 have been read from a data source and populated in section 514. Similarly, the options for drop down selection 532 have been read from a data source and populated in section 512. As a result, future requests for the web page will not have to expend the time and resources to obtain the data in sections 512 and 514.

FIG. 5C is an exemplary excerpt of the final output that is returned to a web browser as a result of the request. In the exemplary output, sections 512 and 514 remain as previously processed and placed in the JIT cache. Thus, no additional processing is necessary, as the desired information has been cached. In addition, elements between the retain tags have been processed resulting in the replacement of the retain tags with user-specific fields and data. For example, the user provided data for e-mail address 540. As a result, e-mail section 520 of the final output illustrated in FIG. 5C was processed and the tag values were replaced during the JIT cache processing illustrated in FIG. 3B to reflect the user specified data.

### Conclusion

Systems and methods generating HTML from various sources including page scripts, databases, and cache files are disclosed. From the foregoing detailed description, it will be appreciated by those skilled in the art that embodiments of the invention provide advantages over previous systems. For example, the systems and methods of the invention provide a mechanism to generate HTML code from scripts faster than was possible in previous systems, while reducing resources required to generate the HTML. In addition, the systems and methods of the invention provide a reasonable balance between the resources that would be required to cache every variation of a web page due to user-specific data, and caching no information at all when user-specific data is present.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A method for generating web page code, the method comprising:
receiving a request identifying a template file;
determining if a previously generated cached file corresponding to the template file exists in a JIT cache; and
if the previously generated cached file exists in the JIT cache, then
replacing a set of one or more retain tags in the previously generate cached file with data from a first data source,
otherwise performing the tasks of:
retrieving the template file,
replacing a set of non-retain tags in the template file with data from a second data source to create the previously generated cached file in the JIT cache.

2. The method of claim 1, wherein the second data source is a database.

3. The method of claim 1, wherein the data source is user-supplied data in an input field.

4. The method of claim 1, further comprising:
determining if a previously created primary cache file exists in a primary cache; and
if the previously created primary cache file exists, then returning the previously cached file to the web page requester.

5. A computerized system for generating web pages comprising:
a JIT cache;
a primary cache;
a web server operably coupled to the JIT cache and the primary cache;
wherein the web server, upon receiving a request for a web page is operable to:
determine if a first cached file associated with the web page exists in the primary cache,
if the first cached file exists, then returning the first cached file to the web page requester,
otherwise performing the tasks of:
determining if a JIT cache file exists in the JIT cache, and
if the JIT cache file exists, then generating web page code by replacing a retain tag in the JIT cache file with a data value from a data source,
otherwise processing a template file associated with the web page.

6. The computerized system of claim 5, wherein the data source is a user-supplied input field.

7. The computerized system of claim 5, wherein the template file is a page script file.

8. The computerized system of claim 7, wherein the page script file is an Active Server Page file.

9. The computerized system of claim 7, wherein the page script file is a CGI script.

10. The computerized system of claim 5, wherein the web server is the IIS server.

11. The computerized system of claim 5, wherein the web server is the Apache web server.

12. A computerized system for generating web pages comprising:
a JIT cache; and
a web server operably coupled to the JIT cache;
wherein the web server, upon receiving a request for a web page is operable to:
identify a template file for the web page;
determine if a previously generated cached file corresponding to the template file exists in a JIT cache; and
if the previously generated cached file exists in the JIT cache, then
replacing a set of one or more retain tags in the previously generated cached file with data from a first data source,
otherwise performing the tasks of:
retrieving the template file,
replacing a set of non-retain tags in the template file with data from a second data source to create the previously generated cached file in the JIT cache.

13. The computerized system of claim 12, wherein the first data source is a user-supplied input field.

14. The computerized system of claim 12, wherein the second data source is a database.

15. The computerized system of claim 12, wherein the template file is a page script file.

16. The computerized system of claim 15, wherein the page script file is an Active Server Page file.

17. The computerized system of claim 15, wherein the page script file is a CGI script.

18. The computerized system of claim 12, wherein the web server is the IIS server.

19. The computerized system of claim 12, wherein the web server is the Apache web server.

20. A computer-readable medium having computer executable instructions for performing a method for generating web page code, the method comprising:
receiving a request identifying a template file;
determining if a previously generated cached file corresponding to the template file exists in a JIT cache; and
if the previously generated cached file exists in the JIT cache, then
replacing a set of one or more retain tags in the previously generate cached file with data from a first data source,
otherwise performing the tasks of:
retrieving the template file,
replacing a set of non-retain tags in the template file with data from a second data source to create the previously generated cached file in the JIT cache.

21. The computer readable medium of claim 20, wherein the second data source is a database.

22. The computer readable medium of claim 20, wherein the data source is user-supplied data in an input field.

23. The computer readable medium of claim 20, wherein the method further comprises:
determining if a previously created primary cache file exists in a primary cache; and
if the previously created primary cache file exists, then returning the previously cached file to the web page requester.

24. A computer language for defining a web page template, the language comprising:
a first set of tags in a standard web page language;
a second set of tags that specify that one of the tags in the first set of tags is to be retained in a JIT cache file.

25. The computer language of claim 24, wherein the standard web page language is HTML.

26. The computer language of claim 25, wherein the standard web page language conforms to an Active Server Page script language.

27. The computer language of claim 24, wherein the standard web page language conforms to the CGI script language.

28. The computer language of claim 24, further comprising a third set of tags defining processing for a record set.

29. The computer language of claim 24 wherein the record set is represents rows retrieved from a database.
